(19) United States
(12) Patent Application Publication
(10) Pub. No.: US 2025/0356731 A1
(43) Pub. Date: Nov. 20, 2025

(54) INTEGRATED PAYMENT READER DISPLAY FOR CASHLESS GAMING

(71) Applicant: LNW Gaming, Inc., Las Vegas, NV (US)

(72) Inventors: Martin S. LYONS, Henderson, NV (US); Nicholas E. BANAS, Henderson, NV (US)

(21) Appl. No.: 19/200,989

(22) Filed: May 7, 2025

Related U.S. Application Data
(60) Provisional application No. 63/647,230, filed on May 14, 2024.

(51) Int. Cl. G07F 17/32; G07G 1/12

(52) U.S. Cl. CPC G07F 17/3244; G07G 1/12

(57) ABSTRACT

A disclosed example of usage, via a casino device, of a display contained within a hardened enclosure of a point-of-sale (POS) terminal. An amount is specified for purchase of credits using the display. A POS controller permits, via a communication port of the POS terminal, a passthrough usage of the display by the casino device for the purchase. The casino device provides, to POS terminal, user input for performance of a payment-card transaction. The POS controller further prevents the passthrough usage of the display by the casino device during the payment-card transaction. The POS terminal detects, in response to performance of the payment-card transaction, authorization of the amount. The casino device performs, in response to receipt of the authorization, a funds transfer to a game controller. The game controller increments, based on the amount, a credit meter. The POS controller restores the passthrough usage of the display.

### CROSS-REFERENCE TO RELATED APPLICATION(S)

This patent application claims priority benefit of U.S. Provisional Patent Application No. 63/647,230 filed May 14, 2024, which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2025, LNW Gaming, Inc.

### FIELD

The present invention relates generally to apparatus and methods for cashless game funding, such as via payment card.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines as well as those machines, or systems, that are easy to use. Funding a gaming session for a gaming machine has typically been performed using a form of physical value, such as cash or physical vouchers. However, many patrons find value in being able to fund gaming sessions without the use of cash or physical vouchers, such as via the use of payment cards (e.g., debit cards, credit cards, etc.). However, some conventional card payment systems, such as Payment Card Industry (PCI) approved systems, provide a semi-integrated point-of-sale (POS) system having a hardened, independent payment terminal (also referred to as a POS terminal) that is separate from a merchant device and which communicates with other authorized POS components, with payment service provider system components, etc. The use of a separate, hardened payment terminal ensures security and ease of updating the PCI approved hardware and software. However, an independent payment terminal would need to be externally mounted to a gaming machine cabinet. Gaming machines are often positioned so close to each other on a casino floor that any externally mounted payment terminal either would interfere with placement of the gaming machines adjacent to each other in a bank, would interfere with access to gaming-machine peripherals (e.g., a bill acceptor, a printer, etc.), and/or would restrict access to the internals of the gaming machine. Therefore, there is a need for an innovative cashless product that includes an approved (e.g., PCI compliant) secure card payment system, such as a payment terminal, in a way that does not interfere with or restrict gaming-machine space, access, usage, etc.

### SUMMARY

According to an embodiment of the present disclosure, a method includes receiving, by a processor associated with a casino device that is connected to a casino network, user input. The user input is received via a display contained within a hardened enclosure of a point-of-sale (POS) terminal. The hardened enclosure contains a POS controller. The POS controller permits, via a communication port of the POS terminal, a passthrough usage of the display by the casino device to receive the user input. An amount is specified for purchase of credits for gaming use. In one example, the method further provides, via a communication device of the POS terminal, the user input for performance, by the POS controller, of a payment-card transaction for the purchase of credits with a payment service provider (PSP) system. The POS controller prevents the passthrough usage of the display by the casino device during the payment-card transaction. In one example, the method further detects, in response to the POS controller performing the payment-card transaction, authorization of the amount. The method further performs, in response to receipt of the authorization, a funds transfer to a game controller accessible to the casino device via the casino network. The game controller increments, based on the amount, a credit meter associated with a gaming session. The POS controller restores the passthrough usage of the display after the authorization is provided.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of an example network according to one or more embodiments of the present disclosure.

FIG. 2 illustrates an example architecture according to one or more embodiments of the present disclosure.

FIG. 3 is a schematic view of a gaming system according to one or more embodiments of the present disclosure.

FIG. 4 is a block diagram of a computer system according to one or more embodiments of the present disclosure.

FIG. 5 illustrates an example of a method flow of automatically managing gaming payment-card transactions via a POS terminal according to one or more embodiments of the present disclosure.

FIGS. 6A and 6B are illustrations of managing casino content, via a POS terminal, for initial selection of an amount for a payment-card transaction according to one or more embodiments of the present disclosure.

FIGS. 7A, 7B, 8A, and 8B are illustrations of managing payment-card transaction content, via a POS terminal, for a payment card transaction according to one or more embodiments of the present disclosure.

FIG. 9A is an illustration of incrementing, via funds transfer, a credit meter with credits purchased via the payment-card transaction according to one or more embodiments of the present disclosure.

FIG. 9B is an illustration of managing additional casino content related to printing of payment card transaction information according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings, and will herein be described in detail, at least some embodiments with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

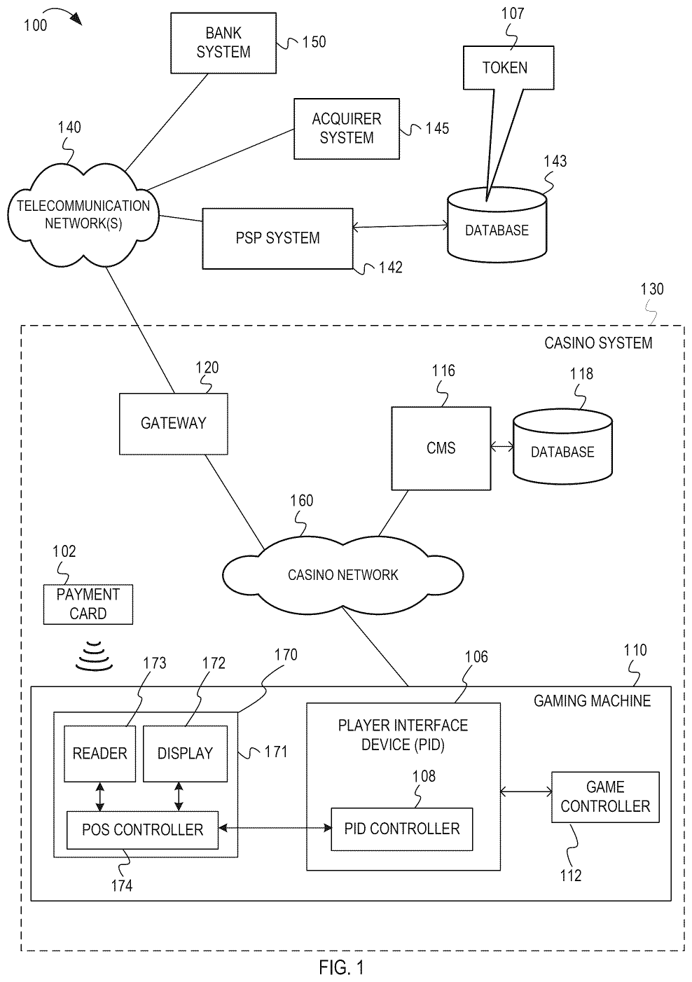

FIG. 1 is a diagram of an example network (“network 100”) according to one or more embodiments of the present disclosure. The network 100 includes a bank system 150, an acquirer system 145, and a payment service provider (PSP) system 142 communicatively coupled (e.g., connected within the network 100) to each other via one or more telecommunication networks (i.e., “telecommunication network(s) 140”). In some embodiments, the telecommunication network(s) 140 include, but are not limited to, the Internet, a computer network, a cell phone communication network, etc. In one embodiment the acquirer system 145 is associated with a bank of a casino operator (e.g., a bank with which a casino operator has a bank account (e.g., the “casino's bank” or the “merchant bank”)). In one embodiment, the bank system 150 is associated with (e.g., belongs to, is authorized by, etc.) a bank that issued a payment card (e.g., payment card 102, such as a debit card) being used by a player (i.e., the “issuer's bank” or the “player's personal bank”). In some embodiments, the bank system 150 is a combination of different third-party (e.g., non-casino) systems associated with one or more of the issuer of the card, a bank by which the card is paid, a bank that provides a bank account tied to the card (e.g., as in the case of payment-card transactions), etc. The various third-party systems authorize use of, and or access to, the PSP system 142, via authorized connections, subscriptions, devices (e.g., POS terminal 170), etc. A payment service provider (PSP) is a third-party (e.g., non-casino) company that assists businesses to accept a wide range of online payment methods, such as online banking, credit cards, debit cards, e-wallets, cash cards, etc. PSPs manufacture and provide payment devices, also referred to as payment terminals, Point-of-Sale (POS) terminals, POS systems, etc. that comply with regulatory security standards, such as compliance with the Payment Card Industry Data Security Standard (PCI DSS), (i.e., also referred to as “PCI compliance”). For instance, the POS terminal 170 is PCI compliant to at least to some level of the PCI DSS. The POS terminal 170 is authorized to communicate encrypted sensitive payment-card information with the PSP system 142. The POS terminal 170 includes a hardened enclosure 171 which contains, at least, a display 172, a payment card reader (reader 173) and a POS controller 174 configured to control access to the reader 173 and the display 172. In one embodiment, the POS terminal 170 requires a PIN entry, such as for use with debit cards.

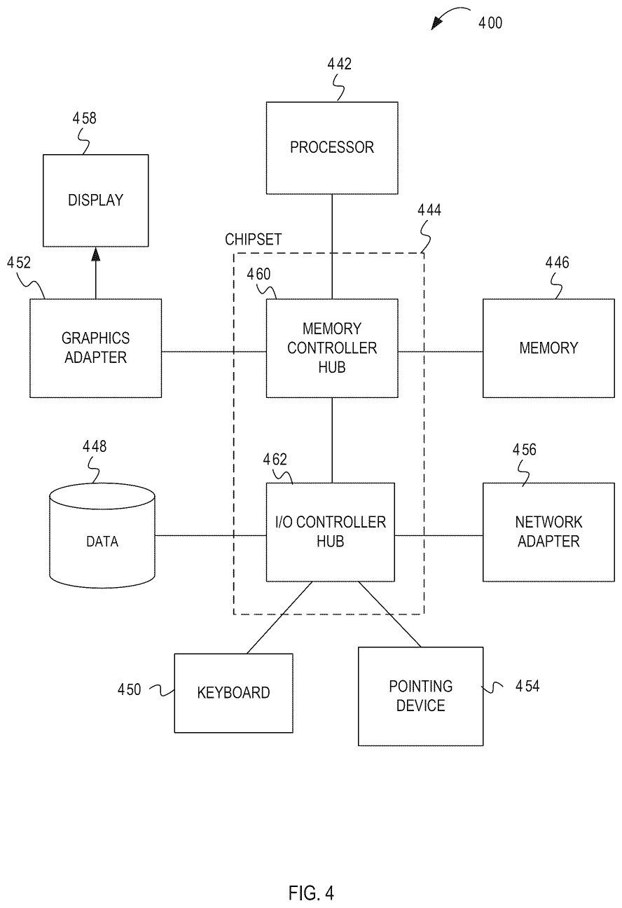

The PSP system 142 is communicatively coupled to a gateway or proxy (e.g., gateway 120). The gateway 120 is communicatively coupled via a gaming network, (e.g., via casino network 160) to a casino management system (“CMS”) 116, which is communicatively coupled to player interface device 106 (also via the casino network 160). The CMS 116 is authorized to perform transactions with, and/or to securely communicate with, the player interface device 106. The gateway 120 is also communicatively coupled (via the telecommunication network(s) 140) to the PSP system 142. The gateway 120 may be a server, a desktop computer, a laptop, a smartphone, a gaming machine, or other form of electronic device having one or more processors, a computer memory, an electronic communications system (e.g., a bus, a network interface device, a wireless communications device, etc.), etc. For instance, the gateway 120 may be the computer system 400 described in FIG. 4. In some embodiments, the gateway 120 is configured to receive instructions from the player interface device 106 and/or the CMS 116 pertaining to payment-card transactions. In some embodiments, some combination of one or more of the player interface device 106, the CMS 116, database 118, and/or the gateway 120 may be collectively referred to as a “player tracking system,” a “patron management system,” a “cashless casino system,” etc., or more generally as, or part of, the casino system 130. The CMS 116 provides (via the player interface device 106) “system-based content” and/or “system-based services.” The system-based content and/or system-based services may include, but are not necessarily limited to, content related to player benefits, casino services, marketing bonuses, promotions, advertisements, beverage or dining services, or any other information that is relevant to the player's gaming experience other than the wagering game itself. Content for a wagering game may be referred to as game content. Game content, for instance, includes game assets of the wagering game, content related to a bet placed on the game (e.g., bet meters, pay tables, payout/collection, credit meters, number of lines selected for betting, an amount bet per line, a maximum bet, etc.), game play elements of the game (e.g., reels, indicia, game symbols,), game instructions, etc. Examples of the CMS 116 include, but are not limited to, one or more of the ACSC Casino Management System™ product, the SDS™ slot-management product, the CMP™ player-tracking product, the Elite Bonusing Suite™ product, or the Bally Unified Wallet product, all available from Light & Wonder, Inc.

The CMS 116 is configured to transmit authorization instructions to the player interface device 106 to fund a game controller 112 via funds transfer. The gateway 120 is configured to track and maintain a history for operations and transactions that occur via communications with devices or systems that are external to a casino system 130 (e.g., with the PSP system 142, the acquirer system 145, and/or the bank system 150) as well as with devices or systems that are internal to the casino system 130 (e.g., with the CMS 116, the database 118, a gaming machine 110, the player interface device 106, the game controller 112, etc.). In some embodiments, the CMS 116 can aggregate data related to transactions with the external devices/systems as well as transactions that occur by various devices of the casino system 130.

The POS terminal 170 is a hardened device that is incorporated into a form factor of (e.g., mounted to an inside of a casing or cabinet of, positioned within a physical enclosure of, etc.) a casino device such as the player interface device 106, the gaming machine 110, etc., yet incorporated in a way that permits the POS terminal 170 to maintain PCI compliance. The POS terminal 170 includes an independent processor (e.g., via POS controller 174) which, in at least one embodiment, is communicatively coupled to the player interface device 106 via a communication device, such as a Universal Serial Bus (USB) connection device and/or an Ethernet connection device, as well as a display port connecter to pass display signals from the player interface device 106 (e.g., to present video content) to the display 172. In another embodiment, the POS terminal 170 may be communicatively coupled to the CMS 116 (e.g., via Ethernet, without being communicatively coupled to player interface device 106). The video signals present content (e.g., system-based content) related to purchase credits for gaming purposes. In one example, if a player is logged into a player account via the player interface device 106, the content that the player interface device presents, via the display 172, includes options to perform other operations related to credit purchases, such as options to manage purchase limits associated with a player account.

In some embodiments, the player interface device 106 is communicatively coupled to a game controller 112 and is configured to communicate with the game controller 112. In some embodiments, the player interface device 106 can intercept an image feed of gaming content from the game controller 112 and rescale the gaming content to fit as a picture-in-picture within a player user interface that presents system-based content, such as content related specifically to a player account (such as customer loyalty benefit information, earned rewards points, player funds, promotions, bonus games, etc.). The player interface device 106 can also provide access to casino services such as electronic drink deliveries, ordering tickets to casino entertainment, redeeming rewards, etc. Further, in some embodiments, the player interface device 106 is configured to communicate with the gateway 120. In some embodiments, the player interface device 106 is an iView® player interface product by Light & Wonder, Inc. An example description of the iView® product can be found in United States U.S. Pat. No. 8,241,123 to Kelly et al., the entirety of which is hereby incorporated by reference. The gaming machine 110 also includes a game controller 112.

The PSP system 142 stores and retrieves data pertaining to payment-card transactions in one or more databases (e.g., database 143). In at least one embodiment, the database 143 includes a “token vault,” or rather a listing (e.g., a table in the database 143) that stores unique tokens (e.g., generated by the PSP system 142), which tokens are used to identify a particular payment card (e.g., a debit card, a credit card, etc.). The PSP system 142 reuses the unique token value each time a transaction is requested for the particular payment card to which the token is assigned or associated. In one or more embodiments, the database 143 also tracks data associated with each payment-card transaction (“payment-card transaction data”), such a payment-terminal identifier (e.g., for the POS terminal 170), sensitive payment-card information (e.g., for used payment card 102), one or more host tokens (e.g., token(s) that identify the payment card 102), monetary values of transactions (e.g., amounts of money requested to purchase game credits for the gaming machine 110), a date-and-time stamp for transactions, etc. In some embodiments, the transaction record also indicates a type of the transaction (e.g., crediting a gaming machine vs. other types of transactions) and a location associated with the transaction (e.g., a tag ID of the gaming machine 110, a GPS location, etc.).

The network 100 is configured to initiate, by one or more processors of the network 100 (e.g., initiated by PID controller 108), a request to purchase game credits for gaming use via the gaming machine 110. The PID controller 108 is allowed passthrough usage (by POS controller 174), for instance, to the display 172 to present a user input screen to select an amount for purchase request of credits. In other embodiments, a user input is not required to select an amount for purchase as the amount may be specified by default, based on previous play, based on an automated setting or limitation set or imposed on the player account, etc. After detecting the selected amount for the purchase request, the POS controller 174 revokes passthrough usage of the display 172 and uses the display 172 exclusively to conduct a payment-card transaction for the purchase request. After an authorization is provided to the POS terminal 170 (e.g., from PSP system 142) for the amount of the game credit purchase, the player interface device 106 (and/or any other casino devices, such as CMS 116) initiates a funds transfer to the game controller 112 to add credits (equating to the purchase amount) to a credit meter of the gaming machine 110. In one embodiment, the player interface device 106 can control and communicate data (e.g., gaming credit information) directly to the game controller 112 via a Slot Accounting System (SAS) funds transfer, via a virtual Ticket-In-Ticket-Out (TITO) procedure, etc. For example, in one embodiment, the CMS 116 and/or the player interface device 106 use a protocol for electronic transfer of funds (referred to herein as “funds transfer”) to add the amount of the payment-card transaction to the credit meter of the gaming machine 110. The protocol for the funds transfer includes, but is not limited to, the Advanced Funds Transfer (AFT) protocol or the Electronic Funds Transfer (EFT) protocol. AFT is a secure technology for transferring funds between a gaming machine (e.g., the gaming machine 110) and a casino accounting system (e.g., the CMS 116). AFT can be used to transfer funds associated with player tracking accounts (also referred to herein as “player loyalty accounts” or “player accounts”) as well as for anonymous users (e.g., via an anonymous account).

Furthermore, after receiving the authorization for the payment of the payment-card transaction, the POS controller 174 restores passthrough usage of the display 172 to the player interface device 106 to present additional content, such as content related to the credit purchase, content with a print option screen to print a receipt (e.g., via a printer of the player interface device 106, the gaming machine 110, etc.), etc.

Several improvements to the network 110 result from the POS terminal 170. One improvement is that a single display (i.e., the display 172) is shared between the player interface device 106 and the POS terminal 170 depending on the state of the payment-card transaction. A sharing of the display 172 causes the purchase of credits to, from the user's perspective, appear to be performed by one device (e.g., the transaction process, from a player perspective, takes place wholly on the display 172 without needing to interact with an external payment reader). The POS terminal 170 is further incorporated into a form factor of a casino device such that the POS terminal 170 does not appear to be an externally mounted device, and thus is not an externally mounted device that would block or interfere with usage of gaming-machine peripherals or access to gaming-machine internals. Furthermore, because the POS terminal 170 is a hardened device, it can be approved by PCI without affecting anything else in the gaming machine 110. The protocols that the POS terminal 170 must support for communication do not typically change often, thus the POS terminal 170 would not require a high frequency of PCI re-approval.

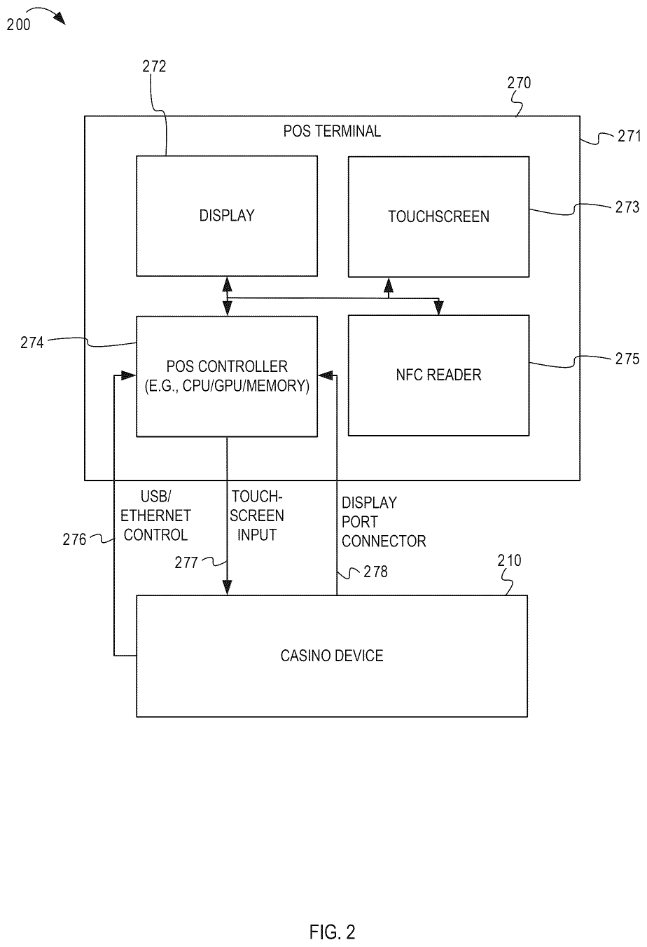

FIG. 2 illustrates an example architecture 200 according to one or more embodiments of the present disclosure. The architecture includes a POS terminal 270 including a hardened enclosure 271 that surrounds the POS terminal 270 and which is hardened (e.g., sealed and/or protected) by the manufacturer of the POS terminal 270 to prevent physical tampering of the POS terminal 270 (e.g., per PCI compliance requirements). The POS terminal 270 also includes a display 272 (also referred to herein as a “hardened” display in that the display 272 is enclosed within the hardened enclosure 271 or a “passthrough” display in that POS controller 274 controls when the display can toggle from a default mode (e.g., a passthrough mode for usage of display 272 by casino device 210) to a secondary mode (e.g., a non-passthrough mode where usage is restricted to only the POS controller 274 during a secure payment transaction, such as a payment-card transaction). In some embodiments, the display 272 can be used as a drop-in ‘dumb’ display, or rather, the display 272 can be set indefinitely to a passthrough mode if the POS terminal 270 (e.g., while functionality of POS terminal 270 to perform payment functions) becomes disabled or is not used.

The POS terminal 270 further includes a touchscreen 273, which is used for PIN entry at a given state of a secure payment transaction, such as for a debit card payment. Thus, in some embodiments, the POS terminal 270 is used for debit card transactions (e.g., in one embodiment, the payment-card transaction is a debit card transaction that requires additional security input, such as a PIN). Similar to the display 272, the touchscreen can be toggled to passthrough usage mode and non-passthrough usage mode (in concert with that of the display 272), for instance, such that the POS controller 274 enables usage of the touchscreen for passthrough usage by the casino device 210 while the display 272 is also in passthrough mode, and the POS controller 274 toggles the touchscreen to non-passthrough mode when the display 272 is also in non-passthrough mode (e.g., when a payment-card transaction is taking place). The switchable passthrough configuration (under the control of the POS controller 274) aids in PCI compliance for the POS terminal 270.

The POS terminal 270 further includes a near field communication (NFC) payment reader (“NFC reader 275”). The NFC reader 275 is wired within the POS terminal 270 and is not accessible outside of the hardened enclosure 271. The NFC reader 275 is used exclusively by the POS controller 274 to obtain sensitive card data such as an account number of a payment card. This sensitive data is not available outside of the hardened enclosure 271. NFC uses radio waves and is a subset of radio-frequency identification (RFID) that uses a specific RFID frequency (13.56 MHz) for close range communications. NFC allows smartphones and devices like payment readers to communicate, and it enables secure, contactless payments (e.g., via payment card, via Apple Pay or Google Pay, etc.). The contactless payments require no physical contact between a payment device (e.g., payment card, smartphone, etc.) and the payment reader. In an NFC payment, a user must tap or hover their payment device (e.g., debit card and/or smartphone) within a given range (e.g., two inches or less) from the NFC reader 275. With NFC, payment card information is encrypted on a user's mobile phone. Mobile payment solutions like Apple Pay and Google Pay use tokenization for heightened security. NFC is also a faster payment method than other types of PCI compliant payment methods, such as dipped chip-card types or magnetic strip card-swipe types of payment methods (e.g., some Europay, Mastercard, and Visa (EMV) or chip card transactions), which can take up to a minute to complete, whereas an NFC payment only takes a few seconds. Further, NFC payments, being contactless, do not permit cloning of the card details when transferred, as is possible with contact types of payment methods. Thus, the NFC reader 275 can prevent customer fraud when used exclusively for contactless payments. In other embodiments, an additional card reader can be incorporated, for example, a second card reader can be positioned adjacent to the display. In other embodiment, a combined reader can be used. The combined reader can be a combined reader for both a loyalty card or a payment card (e.g., a smart card and/or EMV reader, a magnetic strip reader, etc.). For instance, the card reader can be a passthrough reader that permits usage for reading a card of a specific type, such as a player loyalty card, but (similar to the passthrough usage of the display) the POS device can turn off/toggle the passthrough to a secure mode that only permits reading of a payment card for a PCI-compliant payment-card transaction.

The POS terminal 270 includes POS controller 274 (similar to POS controller 174), which includes all components required for control function such as a processor (e.g., a central processing unit (CPU), a graphics processing unit (GPU), etc.), a memory, etc. The POS controller 274 controls access to the display 272 and the touchscreen 273 by a casino device 210. For example, the POS terminal 270 includes communication devices that enable a first communication connection 276 to pass communication controls such as a Universal Serial Bus (USB) control interface/connector and/or an Ethernet type control interface/connector. The communication devices include a second communication connection 277 to pass touch screen inputs (received from touchscreen 273) to the casino device 210 (during passthrough usage mode). The communication devices include a third communication connection 278, such as a display port connector that permits display data (e.g., video output) from the casino device 210 to pass through to the display 272 during passthrough usage mode.

The POS terminal 270 is a PCI approved payment reader (e.g., by a services technology company such as Ingenico, Verifone, etc.). However, the POS terminal 270 has an additional function over conventional payment readers in that the POS terminal 270 allows and/or receives, from time to time, a signal to display video input passed in from its display port connector, rather than video that itself generates. In one embodiment, if required for regulation compliance, the passed through video data can be watermarked or otherwise indicated that it is not being generated by the POS controller 274 itself. When the POS controller 274 enables passthrough usage, content from the casino device 210 is displayed on the display 272. Also, touchscreen inputs from the touchscreen 273 are passed back to the casino device 210. When a payment request is received (during passthrough mode) the POS controller 274 detects the payment request and thereafter disables video and/or touch input passthrough. The POS controller 274 internally generates and displays payment content via the display 272 during non-passthrough mode. In some embodiments, the content that is passed through and/or presentable via the display 272 may be limited to simple templates or types that may permit minimal modification (such as for logo or other branding content to be presented). In one embodiment, after the POS controller 274 completes a secure payment transaction (e.g., after a purchase amount is authorized via a payment card transaction and/or after a funds transfer has been completed and the payment card transaction is closed out), the display 272 becomes usable again by the casino device. For example, the POS controller 274 can generate a signal to switch the display 272 and/or touchscreen 273 back to a passthrough mode, whereby the casino device 210 can use the display 272 to present casino content (e.g., system-based content). In another example, a default mode may automatically re-establish the passthrough usage of the display 272 and/or touchscreen 273.

In one embodiment, the casino device 210 is a player interface device (e.g., player interface device 106). In another embodiment, the casino device 210 is a different gaming device, such as a gaming machine, a display manager system, a virtual button panel (e.g., an iDeck™ virtual button panel product manufactured by Light & Wonder, Inc.), a kiosk, or any other device that is jurisdictionally approved for casino use, and which requires use a display or touchscreen. One advantage to incorporating the POS terminal with a player interface device is that a player interface device is a system-based casino device that can present system-based content or provide casino-system functionality, has access to various systems communicatively coupled to the casino network 160, such as a customer management system, a casino management system, a gateway, an e-wallet application, etc. Furthermore, the POS terminal 270 fits into the form factor of the casino device and is incorporated such that the display 272 and/or touchscreen 273 has a shared or dual use function (e.g., toggles between passthrough and non-passthrough mode), which reduces the amount of hardware required for a gaming system. In an example where a casino device has access to another display, or for some other reason does not require use of the display 272, the POS terminal 270 can be set to a mode that acts purely as a payment reader and does not leave that state. No video is passed through. When not in use for payments, the display can present a default message (e.g., ‘Debit Card Accepted Here’ or other informational message).

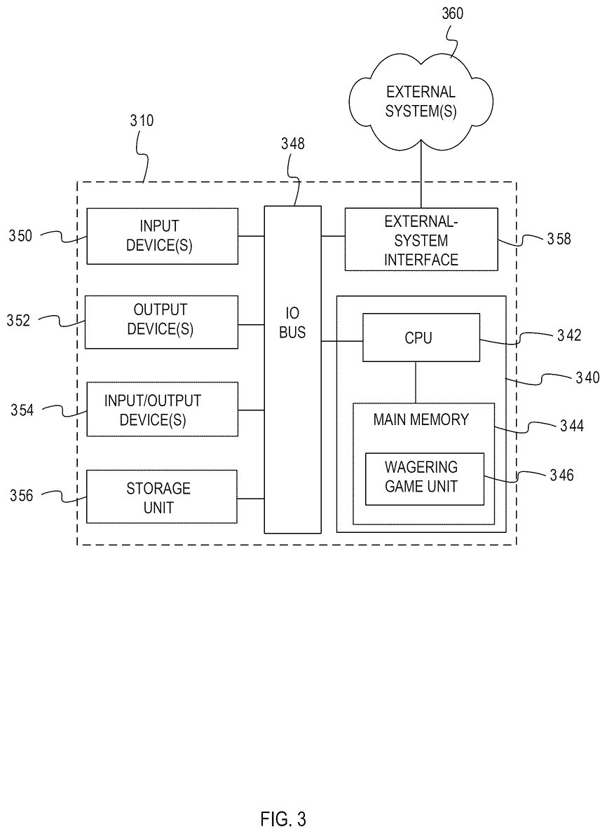

FIG. 3 is schematic view of a gaming system according to at least some aspects of the disclosed concepts. Referring to FIG. 3, a gaming machine 310 includes game-logic circuitry 340 (e.g., securely housed within a locked box inside a gaming cabinet). The game-logic circuitry 340 includes a central processing unit (CPU) 342 connected to a main memory 344 that comprises one or more memory devices. The CPU 342 includes any suitable processor(s), such as those made by Intel and AMD. By way of example, the CPU 342 includes a plurality of microprocessors including a master processor, a slave processor, and a secondary or parallel processor. Game-logic circuitry 340, as used herein, comprises any combination of hardware, software, or firmware disposed in or outside of the gaming machine 310 that is configured to communicate with or control the transfer of data between the gaming machine 310 and a bus, another computer, processor, device, service, or network. The game-logic circuitry 340, and more specifically the CPU 342, comprises one or more controllers or processors and such one or more controllers or processors need not be disposed proximal to one another and may be located in different devices or in different locations. The game-logic circuitry 340, and more specifically a main memory 344, comprises one or more memory devices which need not be disposed proximal to one another and may be located in different devices or in different locations. The game-logic circuitry 340 is operable to execute all of the various gaming methods and other processes disclosed herein. The main memory 344 includes a wagering-game unit 346. In one embodiment, the wagering-game unit 346 causes wagering games to be presented, such as video poker, video blackjack, video slots, video lottery, etc., in whole or part.

The game-logic circuitry 340 is also connected to an input/output (I/O) bus 348, which can include any suitable bus technologies, such as an AGTL+ frontside bus and a PCI backside bus. The I/O bus 348 is connected to various input devices 350, output devices 352, and input/output devices 354.

By way of example, the output devices may include a primary display, a secondary display, and one or more audio speakers. The primary display or the secondary display may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 310. The gaming machine 310 can also include a touch screen(s) mounted over the primary or secondary displays, buttons on a button panel, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The input/output devices 354 include one or more value input/payment devices and value output/payout devices. In one embodiment, a value input/payment device can be used to deposit cash or credits onto the gaming machine 310, the value input devices are configured to detect a physical item associated with a monetary value that establishes a credit balance on a credit meter. The physical item may, for example, be currency bills, coins, tickets, vouchers, coupons, cards, and/or computer-readable storage mediums. The deposited cash or credits are used to fund wagers placed on the wagering game played via the gaming machine 310. Examples of value input devices include, but are not limited to, a coin acceptor, a bill/ticket acceptor (e.g., a bill validator), a card reader/writer, a wireless communication interface (e.g., for reading cash or credit data from a nearby payment device, such as a mobile device, payment card, POS terminal, etc.), and a network interface for withdrawing cash or credits from a remote account via an electronic funds transfer. In response to a cashout input that initiates a payout from the credit balance on the “credits” meter, the value output devices are used to dispense cash or credits from the gaming machine 310. The credits may be exchanged for cash at, for example, a cashier or redemption station. Examples of value output devices include, but are not limited to, a coin hopper for dispensing coins or physical gaming tokens (e.g., chips), a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The I/O bus 348 is also connected to a storage unit 356 and an external-system interface 358, which is connected to external system(s) 360 (e.g., wagering-game networks, communications networks, etc.).

The external system(s) 360 includes, in various aspects, a gaming network, other gaming machines or terminals, a gaming server, a remote controller, communications hardware, or a variety of other interfaced systems or components, in any combination. In yet other aspects, the external system(s) 360 comprises a player's portable electronic device (e.g., cellular phone, electronic wallet, etc.) and the external-system interface 358 is configured to facilitate wireless communication and data transfer between the portable electronic device and the gaming machine 310, such as by a near-field communication path operating via magnetic-field induction or a frequency-hopping spread spectrum RF signals (e.g., Bluetooth, etc.).

The gaming machine 310 optionally communicates with the external system(s) 360 such that the gaming machine 310 operates as a thin, thick, or intermediate client. The game-logic circuitry 340—whether located within (“thick client”), external to (“thin client”), or distributed both within and external to (“intermediate client”) the gaming machine 310—is utilized to provide a wagering game on the gaming machine 310. In general, the main memory 344 stores programming for a random number generator (RNG), game-outcome logic, and game assets (e.g., art, sound, etc.)—all of which obtained regulatory approval from a gaming control board or commission and are verified by a trusted authentication program in the main memory 344 prior to game execution. The authentication program generates a live authentication code (e.g., digital signature or hash) from the memory contents and compares it to a trusted code stored in the main memory 344. If the codes match, authentication is successful, and the game is permitted to execute. If, however, the codes do not match, authentication fails and must be corrected prior to game execution. Without this predictable and repeatable authentication, the gaming machine 310, external system(s) 360, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 342 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 342 when executing the game-outcome logic to determine a resultant outcome for that instance of the wagering game. The resultant outcome is then presented to a player of the gaming machine 310 by accessing the associated game assets, required for the resultant outcome, from the main memory 344. The CPU 342 causes the game assets to be presented to the player as outputs from the gaming machine 310 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 310 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 310 may include additional peripheral devices or more than one of each component shown in FIG. 3. Any component of the gaming-machine architecture includes hardware, firmware, or tangible machine-readable storage media including instructions for performing the operations described herein. Machine-readable storage media includes any mechanism that stores information (e.g., instructions) and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

FIG. 4 illustrates a block diagram of a computer system 400 according to one or more embodiments. The computer system 400 includes at least one processor 442 coupled to a chipset 444, as indicated in dashed lines. Also coupled to the chipset 444 are memory 446, a storage device 448, a keyboard 450, a graphics adapter 452, a pointing device 454, and a network adapter 456. A display 458 is coupled to the graphics adapter 452. In one embodiment, the functionality of the chipset 444 is provided by a memory controller hub 460 and an I/O controller hub 462. In another embodiment, the memory 446 is coupled directly to the processor 442 instead of to the chipset 444.

The storage device 448 is any non-transitory computer-readable storage medium, such as a hard drive, a compact disc read-only memory (CD-ROM), a DVD, or a solid-state memory device (e.g., a flash drive). The memory 446 holds instructions and data used by the processor 442. The pointing device 454 may be a mouse, a track pad, a track ball, or another type of pointing device, and it is used in combination with the keyboard 450 to input data into the computer system 400. The graphics adapter 452 displays images and other information on the display 458. The network adapter 456 couples the computer system 400 to a local or wide area network.

As is known in the art, the computer system 400 can have different and/or other components than those shown in FIG. 4. In addition, the computer system 400 can lack certain illustrated components. In one embodiment, the computer system 400 acting as the gateway 120 (FIG. 1) may lack the keyboard 450, pointing device 454, graphics adapter 452, and/or display 458. Moreover, the storage device 448 can be local and/or remote from the computer system 400 (such as embodied within a storage area network (SAN)). Moreover, other input devices, such as, for example, touch screens may be included.

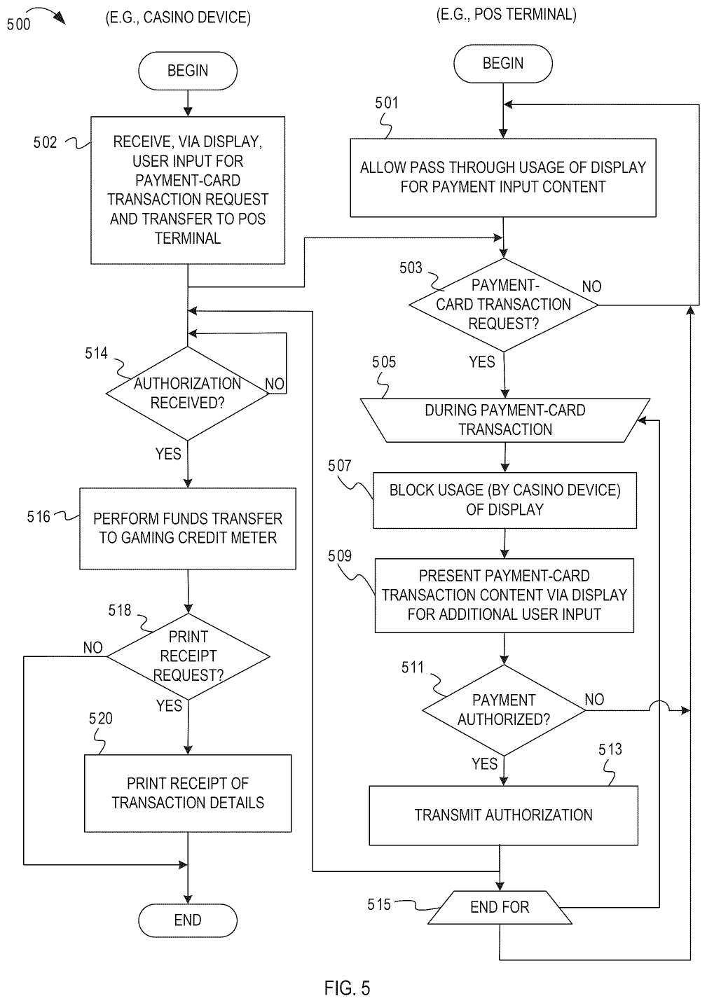

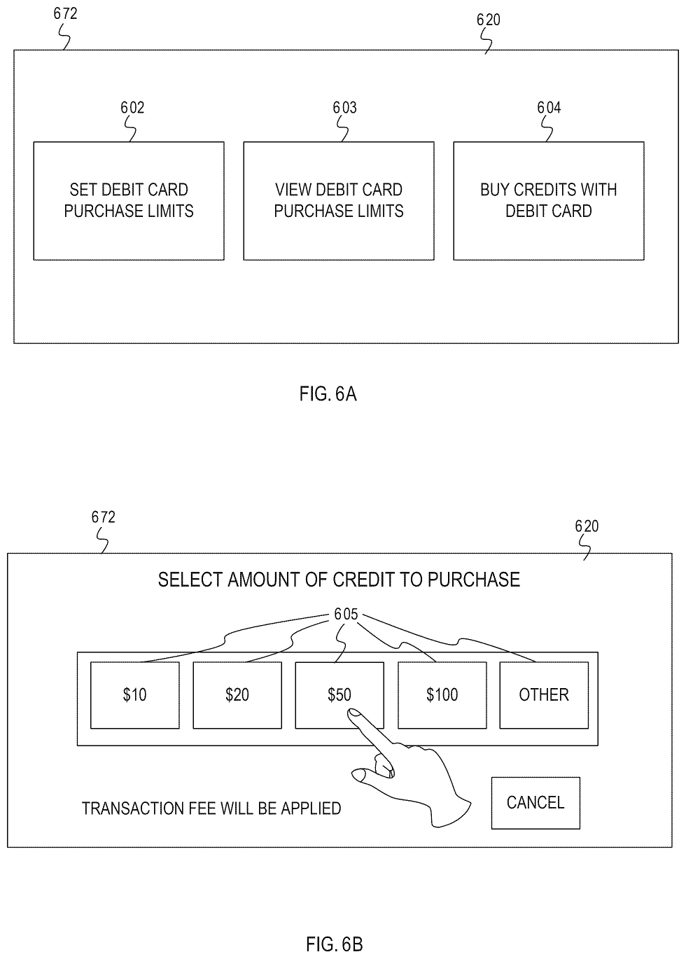

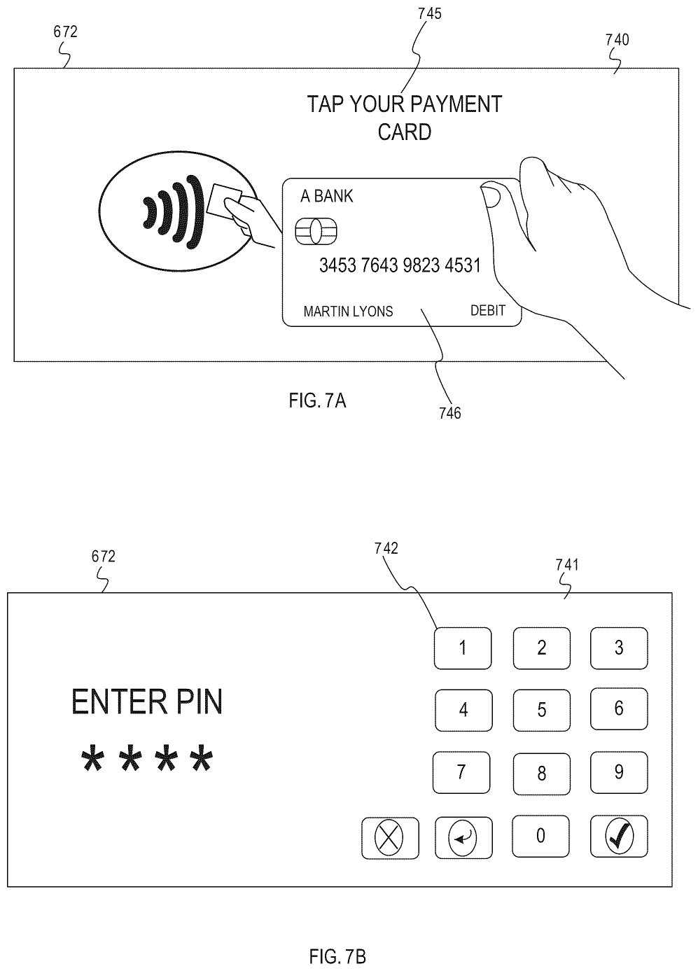

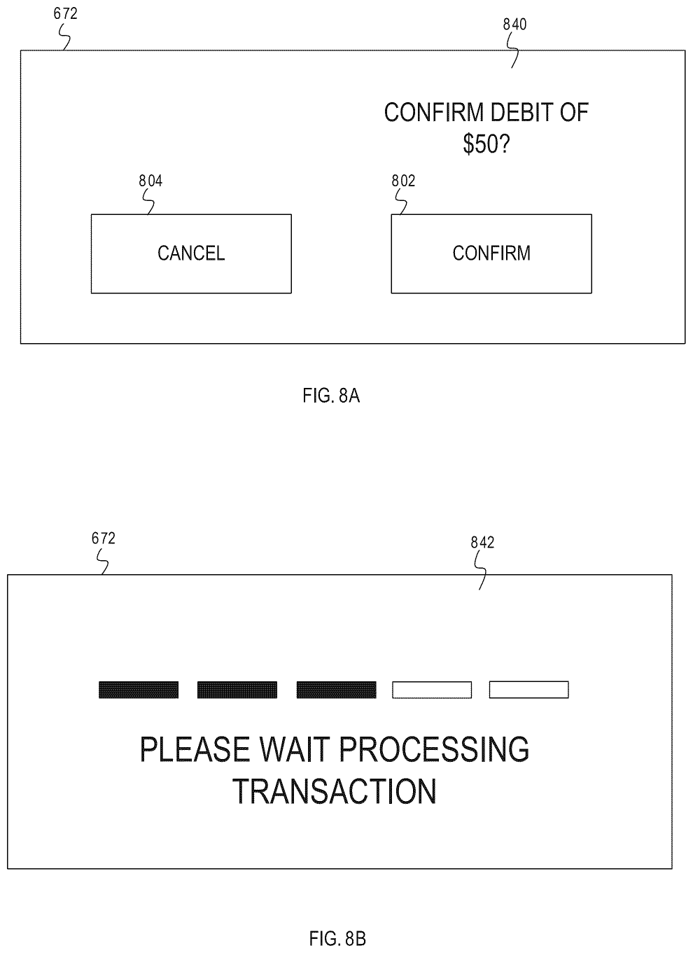

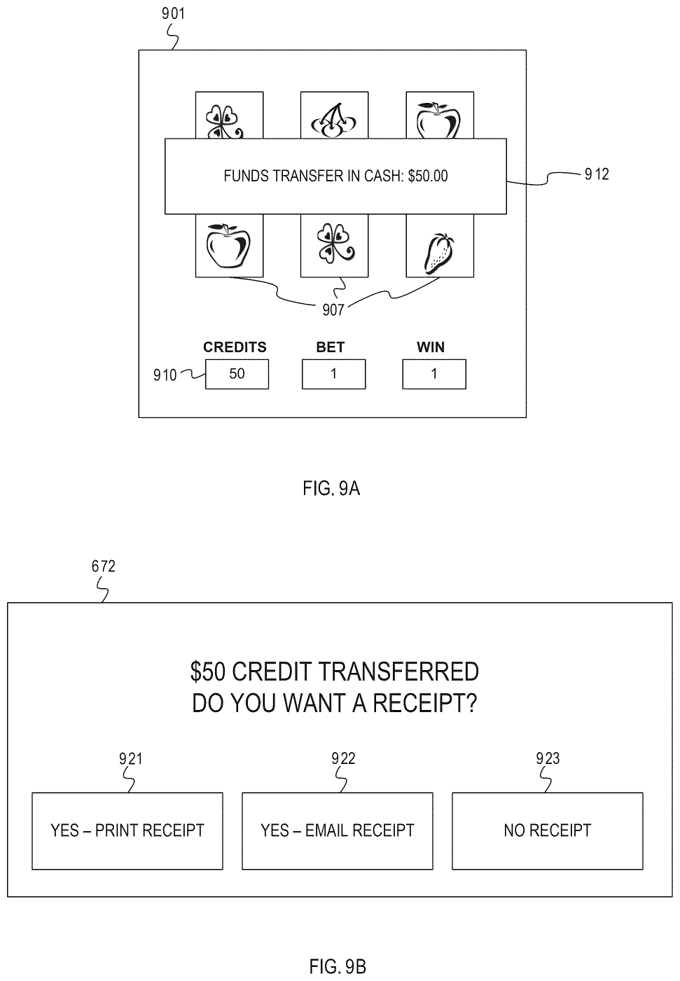

The network adapter 456 (may also be referred to herein as a communication device) may include one or more devices for communicating using one or more of the communication media and protocols discussed herein with respect to FIG. 1, FIG. 2, FIG. 3, FIG. 5, FIG. 6A, FIG. 6B, FIG. 7A, FIG. 7B, FIG. 8A, FIG. 8B, FIG. 9A or FIG. 9B.

In addition, some or all of the components of this general computer system 400 of FIG. 4 may be used as part of the processor and memory discussed above with respect to the systems or devices described for FIG. 1, FIG. 2, FIG. 3, FIG. 5, FIG. 6A, FIG. 6B, FIG. 7A, FIG. 7B, FIG. 8A, FIG. 8B, FIG. 9A or FIG. 9B.

In some embodiments, a gaming system may comprise several such computer systems 400. The gaming system may include load balancers, firewalls, and various other components for assisting the gaming system to provide services to a variety of user devices.

The computer system 400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 448, loaded into the memory 446, and executed by the processor 442.

FIG. 5 illustrates an example of a method flow (“flow 500”) of automatically managing payment-card transactions via a POS terminal according to one or more embodiments of the present disclosure. The description of FIG. 5 refers to a “processor” that performs operations associated with the flow 500. It should be noted that the reference to the processor may refer to the same physical processor or it may be one of a set of a plurality of processors. The set of processors may operate in conjunction with each other and may be distributed across various networked devices (e.g., across the network 100). The types of processors may include a central processing unit, a graphics processing unit, any combination of processors, etc. In one embodiment, the processor may be included in, or refer to, to one or more devices of the network 100, such as any one of the devices connected via the casino network 160 (e.g., gateway 120, CMS 116, gaming machine 110, player interface device 106, POS terminal 170, casino device 210, etc.) or any device connected via the telecommunications network 140 (e.g., the PSP system 142, an acquirer system 145, the bank system 150, etc.). In one embodiment, the processor may be the central processing unit (CPU) 342 (see FIG. 3) or a processor in another device mentioned herein, such as a processor associated with the computer 400, a table controller, a card-handling device, a camera controller, a game controller, a gaming server etc. In another example, the processor may be included in a POS terminal or a POS controller (e.g., included in POS terminal 170, POS terminal 270, POS controller 174, POS controller 274, etc.). During the flow 500, by way of example, two separate processors may be referred to in relation to an example casino device (e.g., casino device 210, player interface device 106, gaming machine 110, gaming machine 310, computer system 400, etc.) and in relation to a POS terminal (e.g., POS terminal 170 or POS terminal 270).

In FIG. 5, the flow 500 begins at processing block 501, where a processor (e.g., a processor associated with a POS terminal, such as POS terminal 170 or POS terminal 270) allows pass through usage of a display for presentation of payment input content. In one example, the payment input content is for presentation of a payment request screen to purchase credits for gaming. For example, as shown in FIG. 6A, a processor (e.g., internal to a casino device) passes, through a display port connecter (e.g., via communication device 278), a signal to a display of a POS terminal (e.g., display 672) to present one or more input screens for casino content (i.e., content 620) such as system-based content related to payment card settings or usage. The display 672 is similar to display 172 or display 272. The content 620 includes a first interface control 602 to set payment card purchase limits, a second interface control 603 to view payment card limits, and a third interface controller 604 to purchase credits with a payment card (e.g., with a debit card). As shown in FIG. 6B, after a user selects the third interface control 604, the processor of the casino device further presents, as content 620, payment amount selection screen(s) including interface controls 605 for a player to select specific purchase amounts (e.g., $10, $20, $50, $100, Other) to add as credits to a gaming credit meter for use during a gaming session. In the example shown, a user selects the “$50” amount.

Referring again to FIG. 5, the flow 500 continues at processing block 502, where a processor (e.g., a processor associated with a casino device, such as casino device 210, player interface 106, gaming machine 110, gaming machine 310, computer system 400, etc.) receives, via the display, user input for a payment request and transfers to a POS controller the request. For example, referring momentarily to FIG. 1, after the player has selected the amount for the purchase, the casino device (e.g., player interface device 106) sends a signal to the POS terminal 170 to perform a payment transaction for $50.

In some embodiments, the casino device can perform (e.g., in connection with CMS 116) a limit check for the player account based on a requested amount of the purchase. For instance, during the limit check, the CMS 116 searches though the casino and/or player data sources to determine what are the spending limits to which the player account is subject. The CMS 116 can access a player account identifier (e.g., player account identifier 512) via access to a logged-in player account. The CMS 116 examines settings (within the player account or elsewhere) that indicate spending limits and ensures, for instance, that (a) payment-card transaction is not attempting to exceed a casino-wide daily limit and (b) a payment-card transaction is not attempting to exceed any daily limit that the player has set or that other authorized users have previously set for the player. If any of these limits have been reached, the CMS 116 rejects the initial purchase request, and the player is informed (e.g., via the display 672). To determine whether the spending limit is reached, the CMS 116 can search through the database 118 (or any other such database or data source). The data source(s) contain a storage of payment-card transaction records. The CMS 116, thus, can search the database 118 (or other such sources) to detect a player account identifier may have been added to a payment-card transaction record when the payment-card transaction was performed (when the player account was logged in). In other embodiments, the CMS 116 tracks payment-card transactions for the player account as they occur and creates a running total of the transaction amounts for any given spending limits (e.g., casino-wide or personal spending limits). Thus, the CMS 116 can compare the requested amount of a payment-card transaction to a running total to determine whether the requested amount would exceed any given spending limits. Some spending limits may also be imposed on the transaction by the player's bank (e.g., via the bank system 150). Those spending limits may be tracked by the player's bank and may cause the transaction to be rejected at a later stage.

If the casino device (e.g., via CMS 116) permits the purchase request, (i.e., the limit check passed), then the requested amount of credit to purchase is passed to the POS terminal 170 and interaction with the POS terminal 170 begins. For example, the player interface device 106 passes the requested amount to the payment device in a ‘Sale’ command.

Referring again to FIG. 5, the flow 500 continues at processing block 503, where a processor (e.g., of POS terminal) determines whether the payment request was received or detected. If the payment request is received or detected, then the flow continues, at processing block 505, where a subroutine occurs (e.g., by the POS terminal) to conduct a payment-card transaction (e.g., with PSP system 142, in connection with bank system 150, acquirer system 145, etc.). In one embodiment, a POS terminal (e.g., POS terminal 170, POS terminal 270, etc.) first determines whether a previous payment transaction is not in progress. If a previous payment transaction is not already in progress, the POS terminal initiates the subroutine associated with processing blocks 505 through 515.

Referring still to FIG. 5, the flow 500 continues at processing block 507, where a processor (e.g., of POS terminal) prevents usage of the shared display by any casino device during the payment-card transaction (e.g., prevents usage of the display by the casino device until an authorization for the amount of the payment-card transaction is determined and transmitted—see processing blocks 511 and 513). In one example, a processor contained within a POS terminal (e.g., POS controller 274) disables access by a casino device (e.g., by casino device 210) to the shared display and, according to PCI rules prevents execution (via the processor of the POS terminal) of any processes or applications that are not directly related to a secure payment transaction (e.g., the payment-card transaction). In one embodiment, an artificial intelligence (e.g., a machine vision process, a multi-modal large language model, a machine learning model, etc.) can run locally within the hardened terminal (or using an external service over a secure link with the payment processor) and passively check (e.g., every five seconds) to determine whether a player interface device is displaying correct information or whether it is displaying something that looks like a fake entry screen (e.g., a fake PIN/debit entry screen). In one embodiment, an image sensor (e.g., a camera) and/or other sensors can be used (in conjunction with the artificial intelligence) to detect the information being displayed on the passthrough display.

Referring again to FIG. 5, the flow 500 continues at processing block 509 where a processor (e.g., of POS terminal) presents payment-card transaction details via the display. For example, in FIG. 7A a POS terminal presents, via display 672, payment-card transaction content, such as payment card action screen 740. From the user perspective, the display 672 presents a seamless transition from the presentation of content 620 to the presentation of the payment card action screen 740. The payment card action screen 740 specifies, via the display 672, a message 745 to ‘Tap Your Payment Card’. In response to detecting a tap of payment card 746, an NFC reader (e.g., NFC reader 275) detects the tap, and signals to the processor of the POS terminal to present, as shown in FIG. 7B, a personal identification number (PIN) entry screen 741 to receive user input that indicates a PIN entry (e.g., via use of virtual button pad 742). After the PIN is entered correctly, the POS terminal presents, as illustrated in FIG. 8A, a payment confirmation screen 840 with interface control options 802 and 804 to either confirm the amount or to cancel the payment-card transaction. As shown in FIG. 8B, the POS terminal presents (e.g., in response to selection of the control option 802) a processing transaction screen 842 while conducting the payment-card transaction.

Referring momentarily to FIG. 1, in one example, during the payment-card transaction, the POS terminal (e.g., POS terminal 170) encrypts payment-card transaction data and communicates it to the PSP system 142 (e.g., via the player interface device 106, the CMS 116, and the gateway 120). The encrypted data remains secure as it passes from the POS terminal 170 through the player interface device 106, the CMS 116, and the gateway 120 enroute to the PSP system 142. This ensures that neither the player interface device 106, the gaming machine 110, the gateway 120, nor the CMS 116 ever has access to the sensitive payment-card information, such as primary account numbers (PANs) or PINs. In one embodiment, the gateway 120 is a firewalled, limited private connection through the Internet to the PSP system 142. The PSP system 142 tokenizes the encrypted data. For instance, the PSP system 142 decrypts the encrypted data and replaces the sensitive payment-card information with a token (e.g., token 107). The POS terminal 170 sends tokenized payment-card transaction data to the acquirer system 145. For example, the POS terminal 170 packages and transmits the portion of the payment-card transaction data that was not sensitive information (e.g., the requested amount) along with the token 107. The data sent by the POS terminal 170 to the acquirer system 145 may be referred to as “tokenized transaction data.” The acquirer system 145 receives the tokenized transaction data (e.g., via the player interface device 106, the CMS 116, the gateway 120, and the PSP system 142) and de-tokenizes the tokenized transaction data (e.g., via communication with the PSP system 142), to determine any necessary information based on the token 107, such as a primary account number of the payment card 102. After de-tokenizing the tokenized transaction data, the acquirer system 145 performs a bank account check. For instance, the acquirer system 145 communicates, via the telecommunications network(s) 140 with the bank system 150 (which has access to the player's bank account associated with the primary account number of the payment card 102). The bank system 150 authorizes the requested amount of the payment-card transaction if the player's bank account has sufficient funds to cover the requested amount. If the player's bank account has insufficient funds, the bank system 150 would reject the completion of the payment-card transaction. The bank system 150 communicates the authorization to the POS terminal 170. The authorization includes all necessary information to complete the payment-card transaction, such as the requested payment amount, the token 107, etc. In one embodiment, the POS terminal provides the token 107 to the casino device (e.g., to the CMS 116 via the player interface device 106). In another embodiment, the casino device can obtain or detect the token 107. In one embodiment, in response to obtaining or detecting the token 107, the casino device stores and associates the token 107 with a player account to analyze past payment-card transactions within a given period against a spending limit as described in U.S. patent application Ser. No. 18/474,941, filed Sep. 26, 2023, the contents of which are incorporated by reference herein.

Referring again to FIG. 5, the flow 500 continues at processing block 511, where a processor (e.g., of POS terminal) determines whether the payment amount (e.g., credit purchase amount) of the payment-card transaction is authorized. If, at processing block 511, the processor determines that the payment amount is authorized, the flow 500 continues at processing block 513, where a processor (e.g., of POS terminal) transmits the authorization of the amount to the casino device. For example, the PSP system provides an authorization of the credit purchase amount. The flow 500 then continues at processing block 514, where a processor (e.g., of the casino device) determines whether the authorization for the payment-card transaction was provided or detected. If at processing block 514, the processor (e.g., of casino device) determines that the authorization is provided or detected, at processing block 516, the processor (e.g., of casino device) performs a funds transfer to a gaming credit meter (e.g., from an e-wallet gaming account associated with CMS 116, via a casino payment server, etc.). In one example, the POS terminal communicates to the casino device the authorized amount for the payment-card transaction. In one example, the casino device may be a player interface device (e.g., player interface device 106) which in turn informs a local casino server (e.g., CMS 116 or other casino payment server). For example, referring to FIG. 1, the CMS 116 (via the player interface device 106) can send a funds transfer command (e.g., via Slot-Account-System (SAS), virtual Ticket-In-Ticket-Out (TITO), etc.) to the game controller 112 to add gaming credits, for the requested amount, to a credit meter of the gaming machine 110. For example, as shown in FIG. 9A, a display 901 of gaming machine 110 shows a credit meter 910 that is incremented in the amount of credits that corresponds to the requested amount (e.g., via conversion of a given denomination selection of the gaming machine to a credits value). Once the funds transfer is complete, the game controller 112 then transmits a transfer completion response.

Referring again to FIG. 5, the flow continues at processing block 518, where a processor (e.g., of casino device) determines whether a request is received, in response to further user input made via the display, to print a receipt of the transaction. If the print request is received, then the flow continues at processing block 520 where the processor (e.g., of casino device) prints the receipt of the transaction details. For instance, as shown in FIG. 9B, the casino device presents additional content for additional user input (e.g., via interface controls 912, 922, and 923) to select an option for printing.

FIG. 5 described by way of example above, represents one or more data processing methods (e.g., algorithm(s)) that correspond to at least some instructions stored and executed by one or more processors and/or logic circuitry, such as those associated with a casino device (e.g., player interface device 106, casino device 210, etc.) and/or those associated with a POS terminal. Other embodiments can utilize processors and/or logic circuitry of any of the devices described for FIG. 1, FIG. 2, FIG. 3, FIG. 4, FIG. 6A, FIG. 6B, FIG. 7A, FIG. 7B, FIG. 8A, FIG. 8B, FIG. 9A or FIG. 9B to perform the above described functions associated with the disclosed concepts in different ways. For example, in some embodiments, a player interface device is not used, rather a gaming machine (e.g., gaming machine 110 or gaming machine 310) can be in direct communication with CMS 116 and can transmit, to the CMS 116, payment related information, including authorized payment amounts of a payment-card transaction, tokens for any payment-card transactions that occur at the gaming machine, etc.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A method comprising:
receiving, by a processor associated with a casino device connected to a casino network, user input, wherein the user input is received via a display contained within a hardened enclosure of a point-of-sale (POS) terminal, wherein the hardened enclosure comprises a POS controller, wherein the POS controller permits, via a communication port of the POS terminal, a passthrough usage of the display by the casino device to receive the user input, and wherein an amount is specified for purchase of credits for gaming use;
providing, by the processor via a communication device of the POS terminal, the user input for performance, by the POS controller, of a payment-card transaction, with a payment service provider (PSP) system, for the purchase of credits, and wherein the POS controller prevents the passthrough usage of the display by the casino device during the payment-card transaction;
detecting, by the processor in response to performance by the POS controller of the payment-card transaction, authorization of the amount; and
performing, by the processor in response to receipt of the authorization, a funds transfer to a game controller accessible to the casino device via the casino network, wherein the game controller increments, based on the amount, a credit meter associated with a gaming session, and wherein the POS controller restores the passthrough usage of the display after the authorization is provided.

2. The method of claim 1, wherein the POS terminal is incorporated into a form factor of the casino device.

3. The method of claim 1, wherein the POS controller is compliant with the Payment Card Industry Data Security Standard (PCI DSS) to conduct the payment-card transaction.

4. The method of claim 1 further comprising:
receiving, via the POS controller from the casino device, a transmission of the user input, wherein the transmission indicates the amount;
disabling, by the POS controller, the passthrough usage of the display by the casino device;
presenting, by the POS controller, a message to tap a payment card against the display;
detecting, via a near field communication (NFC) reader contained within the hardened enclosure of the POS terminal, a tap of the payment card;
presenting, by the POS controller via the display, a personal identification number (PIN) entry screen for input of a PIN for the payment card;
performing, by the POS controller in response to receipt of the PIN, the payment-card transaction with the PSP system; and
transmitting, by the POS controller in response to receipt of a payment authorization obtained from the PSP system, the authorization of the amount of the payment-card transaction to the processor associated with the casino device.

5. The method of claim 4, wherein the NFC reader is wired within the hardened enclosure and is not accessible outside of the hardened enclosure to the casino device.

6. The method of claim 4, wherein the POS controller encrypts sensitive data of the payment card during communication with the PSP system, and wherein the sensitive data is not available to the casino device.

7. The method of claim 1 further comprising:
receiving, by the processor during the payment-card transaction, a host token provided by the PSP system in place of sensitive data of the payment card; and
using, by one or more of the processor or one or more controllers associated with a casino server, the host token for tracking player purchases for enforcement of spending limits.

8. The method of claim 1, wherein the hardened enclosure of the POS terminal is mounted within a portion the casino device, wherein the POS terminal includes a touchscreen accessible via the passthrough usage of the display, wherein the touchscreen receives, during passthrough usage, a first input screen to specify a payment amount, wherein during the payment-card transaction the POS controller presents at least one of a payment card action screen, a personal identification number (PIN) entry screen, a payment confirmation screen, or a transaction processing screen, and wherein after the payment-card transaction is completed the POS controller restores the passthrough usage of the display for presenting, by the processor associated with the casino device, a second input screen to receive, via the touchscreen, additional user input to request printing of a receipt.

9. The method of claim 1 further comprising printing, by the processor in response to additional user input via the display after performance of the funds transfer, a receipt of the payment-card transaction via a printer associated with the casino device.

10. A system comprising:
a point-of-sale (POS) terminal having a hardened enclosure including a display, a touchscreen, and a POS controller, wherein the POS controller permits, via a communication port of the POS terminal, a passthrough usage of the display and the touchscreen by a casino device;
one or more processors configured to execute instructions that, when executed, cause the system to perform operations to:
present, via passthrough usage of the display, content to initiate a purchase request of credits for gaming use;
receive, via passthrough usage of the touchscreen, user input, wherein an amount is associated with the purchase request;
provide, to a communication device of the POS terminal, the user input for performance, by the POS controller, of a payment-card transaction with a payment service provider (PSP) system, wherein the POS controller prevents the passthrough usage of the display by the casino device during the payment-card transaction;
detect, in response to performance by the POS controller of the payment-card transaction, authorization of the amount; and
perform, in response to receipt of the authorization, a funds transfer, via a casino network, to a game controller accessible to the casino device, wherein the game controller increments, based on the amount, a credit meter associated with a gaming session, and wherein the POS controller restores the passthrough usage of the display after the authorization is provided.

11. The system of claim 10, wherein the POS terminal is incorporated into a form factor of the casino device.

12. The system of claim 10, wherein the POS controller is compliant with the Payment Card Industry Data Security Standard (PCI DSS) to conduct the payment-card transaction.

13. The system of claim 10, wherein the one or more processors are further configured to execute instructions that, when executed, cause the system to perform operations to:
receive, via the POS controller from the casino device, a transmission of the user input, wherein the transmission indicates the amount;
disable, by the POS controller, the passthrough usage of the display by the casino device;
present, by the POS controller, a message to tap a payment card against the display;
detect, via a near field communication (NFC) reader contained within the hardened enclosure of the POS terminal, a tap of the payment card;
present, by the POS controller via the display, a personal identification number (PIN) entry screen for input of a PIN for the payment card;
perform, by the POS controller in response to receipt of the PIN, the payment-card transaction with the PSP system; and
transmit, by the POS controller in response to receipt of a payment authorization obtained from the PSP system, the authorization of the amount of the payment-card transaction to the casino device.

14. The system of claim 13, wherein the NFC reader is wired within the hardened enclosure and is not accessible outside of the hardened enclosure to the casino device.

15. The system of claim 13, wherein the POS controller encrypts sensitive data of the payment card during communication with the PSP system, and wherein the sensitive data is not available to the casino device.

16. The system of claim 10, wherein the one or more processors are further configured to execute instructions that, when executed, cause the system to perform operations to:
receive, during the payment-card transaction, a host token provided by the PSP system in place of sensitive data of the payment card; and
use the host token to track player purchases for enforcement of spending limits.

17. The system of claim 10, wherein the hardened enclosure of the POS terminal is mounted within a portion the casino device, wherein the touchscreen receives, during passthrough usage, a first input screen to specify a payment amount, wherein during the payment-card transaction the POS controller presents at least one of a payment card action screen, a personal identification number (PIN) entry screen, a payment confirmation screen, or a transaction processing screen, and wherein after the payment-card transaction is completed the POS controller restores the passthrough usage of the display for presentation of a second input screen to receive, via the touchscreen, additional user input to request printing of a receipt.

18. The system of claim 10, wherein the one or more processors are further configured to execute instructions that, when executed, cause the system to perform operations to print, in response to additional user input via the display after performance of the funds transfer, a receipt of the payment-card transaction via a printer associated with the casino device.

19. One or more non-transitory, computer-readable mediums having instructions stored thereon, which instructions, when executed by one or more processors, cause a gaming apparatus to perform operations comprising:
receiving user input, wherein the user input is received via a display contained within a hardened enclosure of a point-of-sale (POS) terminal, wherein the hardened enclosure comprises a POS controller, wherein the POS controller permits, via a communication port of the POS terminal, a passthrough usage of the display by the gaming apparatus to receive the user input, and wherein an amount is specified for purchase of credits for gaming use;
providing, via a communication device of the POS terminal, the user input for performance, by the POS controller, of a payment-card transaction, with a payment service provider (PSP) system, for the purchase of credits, and wherein the POS controller prevents the passthrough usage of the display by the gaming apparatus during the payment-card transaction;
detecting, in response to performance by the POS controller of the payment-card transaction, authorization of the amount; and
performing, in response to receipt of the authorization, a funds transfer to a game controller accessible to the gaming apparatus via the casino network, wherein the game controller increments, based on the amount, a credit meter associated with a gaming session, and wherein the POS controller restores the passthrough usage of the display after the authorization is provided.
